(19) United States
(12) Patent Application Publication
(10) Pub. No.: US 2007/0005952 A1
(43) Pub. Date: Jan. 4, 2007

(54) Boot-up method for computer system

(76) Inventor: Kuan-Jui Ho, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/476,712

(22) Filed: Jun. 29, 2006

(30) Foreign Application Priority Data
Jun. 30, 2005 (TW) 094122190

(51) Int. Cl. G06F 9/00

(52) U.S. Cl. 713/2

(57) ABSTRACT

A boot-up method for a computer system comprises the steps of after turning on the power on the system, a Central Process Unit (CPU) accessing the Basic Input/Output System (BIOS) within the Read Only Memory (ROM) to execute the boot-up self-testing procedure; enabling a cache memory for assisting to quickly execute the initial procedure for the chipset and the system memory; after finishing the initial procedure of the system memory, disabling the cache memory for returning to the general status of the system; executing the initial procedure of the cache memory and other peripheral devices for finishing the boot-up procedure, such that can achieve the purpose of fast boot-up for the system and ensuring the system stability.

### FIELD OF THE INVENTION

The present invention relates to a boot-up method for a computer system.

### BACKGROUND OF THE INVENTION

In the information generation with seizing every minute and second, the execution efficiency of computer facilities is the key point of purchasing for consumers, as well as the one of selling price making reference. Thus, most information manufactures strive for increasing the execution efficiency of computers. According to the demand of portability for computer facilities, most users would like to request that when pressing the power on button, computer facilities can be booted up fast, so as to directly get into the Operation System (OS) for further operation. Consequently, how to speed the boot-up procedure for acomputer system is looked forward for most people.

Referring to FIG. 1, is a block diagram of a computer system with major elements. A general computer system 10 comprises a Central Process Unit (CPU) 11, a chipset 15 comprising a North Bridge chip 151 and South Bridge chip 153. The North Bridge chip 151 connects with the CPU 11 and the South Bridge chip 153, and connects with a system memory 17 and an Accelerated Graphics Port (AGP) 191. The South Bridge chip 153 connects with a Read Only Memory (ROM) 13, a hard disk 194, and other peripheral devices, such as a CD-ROM drive 195, an audio device 196, a serial bus 192, and a Input/Output device 193. Within the computer system 10, the CPU 11 further comprises at least one cache memory 18 for registering the operation data so as to raise the system operation efficiency.

According to various elements and complicated functions of the whole system, therefore, the CPU 11 should be used to execute a serial processes by detecting, testing, and initiating for the hardware, and then the computer system 10 can be operated correctly. The process code of which is called Basic Input/Output System (BIOS) 133, and with preventing from incorrectly modification or alteration to cause system error, and even cannot boot up, the BIOS is used to be stored in the Read Only Memory (ROM) 13.

When the system is turned on, the Power On Self Test (POST) program within the BIOS 133 is firstly executed. The POST program comprises a serial of sub-programs, and each sub-program is executed in order, respectively proceeding the test and initial procedure for the corresponding hardware device. After each hardware device being operated under general status, the computer system 10 goes to load an Operation System (OS) for requiring the operation interface by user demanding.

In accordance with the Read Only Memory (ROM) 13 connecting with South Bridge chip 153 through Industry Standard Architecture (ISA) bus 131 or Low Pin Count (LPC) bus, the CPU 11 executes the POST program through the ISA bus 131 or the LPC bus to read the BIOS 133 data one by one stored within the Read Only Memory (ROM) 13 for testing and initiating the relative hardware devices, when there is no any memories for utilizing. The best transmission rate of the ISA bus 131 goes to 8.33 KHz only, and even the LPC bus can speed up to 33 MHz only; comparing to the recent system operation efficiency, which is too slow. Therefore, when the computer system 10 is on the boot up procedure, such may waste a lot of time for data transmission through the ISA bus 131.

Referring to FIG. 2, is a boot-up flow chart of a prior art within the computer system. The steps comprises turning on the computer system by users, as the step 201; after the power on, the CPU accessing and executing the POST program within the BIOS 202; initiating chipsets, as the step 203, that is, initiating the North Bridge chip and South Bridge chip; detecting a system memory of the computer system by the CPU through the North Bridge chip electrically connecting thereof, and initiating the system memory, as the step 204; initiating the cache memory by the CPU, as the step 205.

After finishing the initial procedure of the cache memory, the CPU can execute other peripheral devices according to assistance of the system memory and the cache memory, as the step 206, such as AGP, serial bus, Input/Output device, hard disk, CD-ROM drive, audio device, and so on. And, the boot up procedure can be finished with loading an Operation System (OS) finally.

Due to the above mentioned prior art, when the CPU initiates the chipset and the system memory, the CPU can only read the relative demand data of the BIOS stored within the Read Only Memory (ROM) one by one, so as to lengthen the demand time for initiating the hardware devices and booting up system. In nowadays with seizing every minute and second, such is regarding as a waste of time.

Accordingly, how to design boot-up method for a computer system, and more particularly to a boot-up method for a computer system with respect to the previous mentioned shortcomings of the prior art boot-up procedure, when initiating the chipset and the system memory, CPU can directly read data from the Read Only Memory (ROM) to the cache memory for conveniently accessing, so as to speed up the system boot-up procedure, is the key point of the present invention.

### SUMMARY OF THE INVENTION

The present invention provides A boot-up method for a computer system, wherein the computer system comprising a Central Process Unit (CPU), a cache memory, a chipset, a system memory, a Read Only Memory (ROM) with Basic Input/Output System (BIOS) therein, and a plurality of peripheral devices, the boot-up method comprising the steps of turning on the power; enabling the cache memory; executing the initial procedure for the chipset; executing the initial procedure for the system memory; disabling the cache memory; executing the initial procedure for the cache memory; executing the initial procedure for the peripheral devices; and loading an Operation System (OS).

### BRIEF DESCRIPTION OF THE DRAWINGS

FIG. 1 is a block diagram of a computer system with major elements;

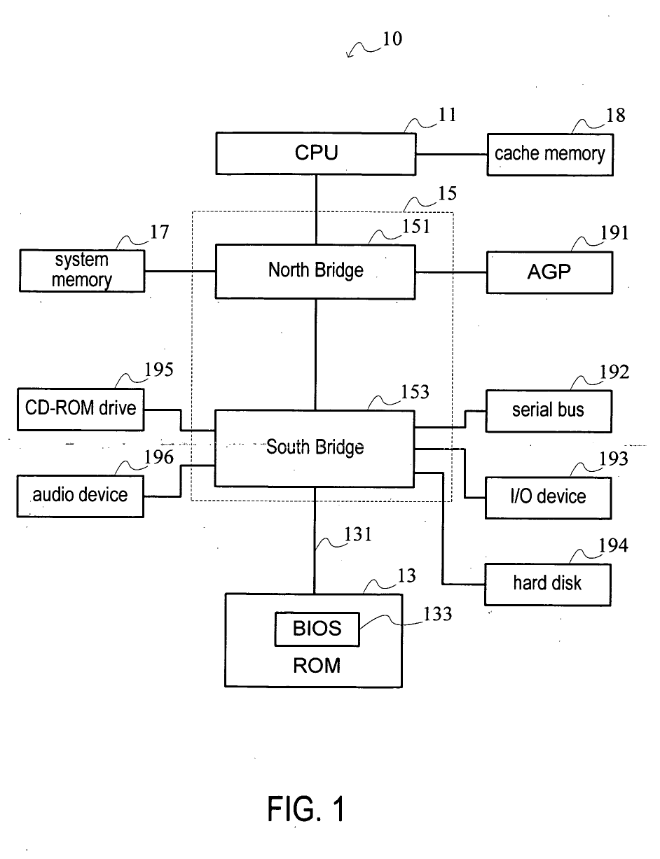

FIG. 2 is a boot-up flow chart of a prior art within the computer system;

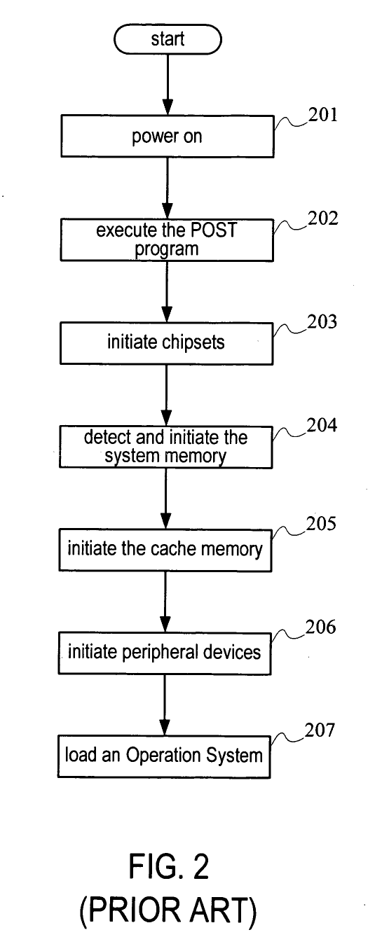

FIG. 3 is a boot-up flow chart of a preferred embodiment of the present invention;

FIG. 4 is flow chart of a preferred embodiment of the present invention according to initiate a system memory.

### DETAILED DESCRIPTION OF THE INVENTION

The structural features and the effects to be achieved may further be understood and appreciated by reference to the presently preferred embodiments together with the detailed description.

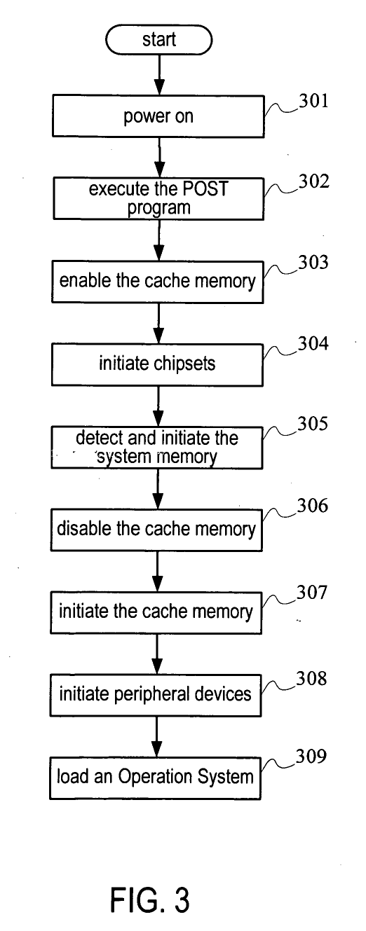

Referring to FIG. 3, is a boot-up flow chart of a preferred embodiment of the present invention. When users turn on the computer system, as the step 301, the boot-up procedure is going to access and execute the POST program by the CPU, wherein the POST program comprises a plurality of sub-programs, stored within the BIOS, which is located in the Read Only Memory (ROM), as the step 302. Further, the cache memory can be used to register data after enabling the cache memory, as the step 303.

Thereafter, the CPU goes to initiate the chipset with the assistance of cache memory, as the step 304. And then, the system memory is further initiated, as the step 305. Thus, the computer system can operate with the system memory for speeding up the further execution, according to enlarge the memory capacity.

Continuously, the cache memory is going to be disabled for going to return general boot-up procedure and preventing the system error occurred unexpectedly, as the step 306. And then, that is going to initiate the cache memory, as the step 307. Therefore, the CPU can fast execute the further initial procedure for the peripheral devices, according to the assistance of the system memory and cache memory, as the step 308. After finishing the testing for the hardware devices, an OS can be loaded, which is as finishing the boot-up procedure for the computer system, as the step 309.

As well as general operation within the computer system, when the CPU would like to read a data, the cache memory is used to be searched firstly. Once there is no such data in the cache memory, then the system memory is the next. And, if there is no such data in the system memory still, then that would go to an address of such data stored within the storage media for next searching, such as hard disk, Read Only Memory (ROM), and so on, wherein the storage media comprises the address for storing such data. Consequently, after disabling the cache memory, as the step 303, initiating the chipset and the system memory by the CPU is with assistance of the cache memory.

When the CPU reads the data from the Read Only Memory (ROM), the data and the following a plurality of data are going to be stored within the cache memory. Thus, when the CPU initiates the chipset and the system memory, the demand data can directly be read from the cache memory without searching the Read Only Memory (ROM) therein repeatedly through the ISA bus, such that can short the time of data transmission and speed up the system boot-up procedure.

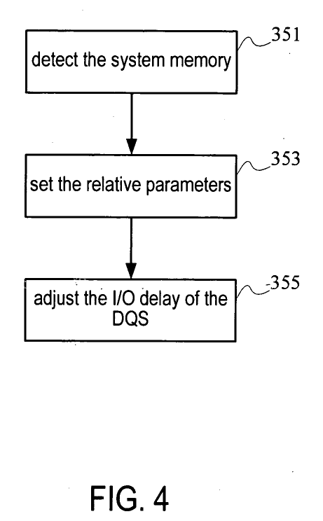

Referring to FIG. 4, is flow chart of a preferred embodiment of the present invention according to initiate a system memory. The system memory within the general computer system is a Random Access Memory (RAM), such as a Static Random Access Memory (SRAM), Dynamic Random Access Memory (DRAM), a Synchronous Dynamic Random Access Memory (SDRAM), a Double Data Rate Random Access Memory (DDR), a Second Generation Double Data Rate Random Access Memory (DDR II), and one of other random access memories.

When the system memory within the computer system is as the Double Data Rate Random Access Memory (DDR), or the Second Generation Double Data Rate Random Access Memory (DDR II), the initial procedure of the system memory comprises steps of detecting the hardware information of the system memory, as the step 351; setting the relative parameters of the system memory, as the step 353; and adjusting the Input/Output delay of the Bi-directional data strobe (DQS), as the step 355.

Wherein, when the stage of setting the relative parameters of the system memory and adjusting the Input/Output delay of the Bi-directional data strobe (DQS), the CPU have to read a lot of data stored within the BIOS, and even have to execute the relative program stored within the BIOS, which can be operated to obtain the Input/Output delay value of the Bi-directional data strobe (DQS), and further adjusting to the required value thereof. With under such circumstance, once the boot-up procedure is still as the prior art, the CPU have to read the data or the program code stored within the BIOS one by one through a low speed bus, such as the ISA bus, which may waste considerable time of data transmission.

Therefore, with respect to the present invention, the CPU can operate with assistance of the cache memory, and the time of boot-up procedure is obviously shorted. In accordance with the present experimental data of testing, the boot-up method of the present invention shows that can be used to speed up 6 to 40 times for the operation speed, which is surely a breakthrough.

According to the present invention, the cache memory is selected as a level 1 cache memory (L1 cache), a level 2 cache memory (L2 cache), a level 3 cache memory (L3 cache), and a combination thereof, all of which are achieved the purpose of speeding up the system boot-up procedure.

In summary, it is appreciated that the present invention is related to a boot-up method for a computer system, and more particularly to a boot-up method for a computer system, according to enable a cache memory for shorting the initial time of the chipset and the system memory, so as to achieve the purpose of fast boot-up the computer system.

The present invention to provide a, which enables the cache memory for registering the data stored within the BIOS, and preventing from repeatedly reading the data within the BIOS through the ISA bus, so as to short the time of data transmission, and further short the time of the system boot-up procedure.

Further, the boot-up method for a computer system, which disables the cache memory, after finishing the initial procedure for the chipset and the system memory, and then initiates the cache memory for going to return general boot-up procedure by preventing from the system error occurred.

The foregoing description is merely one embodiment of present invention and not considered as restrictive. All equivalent variations and modifications in process, method, feature, and spirit in accordance with the appended claims may be made without in any way from the scope of the invention.

I claim:

1. A boot-up method for a computer system, wherein said computer system comprising a Central Process Unit (CPU), a cache memory, a chipset, a system memory, a Read Only Memory (ROM) with Basic Input/Output System (BIOS) therein, and a plurality of peripheral devices, said boot-up method comprising the steps of:
turning on the power;
enabling said cache memory;
executing the initial procedure for said chipset;
executing the initial procedure for said system memory;
disabling said cache memory;
executing the initial procedure for said cache memory;
executing the initial procedure for said peripheral devices; and
loading an Operation System (OS).

2. The boot-up method of claim 1, wherein said cache memory can be selected as a level 1 cache memory, a level 2 cache memory, a level 3 cache memory, and a combination thereof.

3. The boot-up method of claim 1, wherein said chipset comprises a North Bridge chip and a South Bridge chip.

4. The boot-up method of claim 1, wherein said system memory can be selected as a Static Random Access Memory (SRAM), Dynamic Random Access Memory (DRAM), a Synchronous Dynamic Random Access Memory (SDRAM), a Double Data Rate Random Access Memory (DDR), a Second Generation Double Data Rate Random Access Memory (DDR II), and one of other random access memories.

5. The boot-up method of claim 1, wherein the initial procedure for said system memory comprises the steps of:
detecting said system memory;
determining the relative parameters of said system memory; and
adjusting the Input/Output delay of the Bi-directional data strobe (DQS).

6. A boot-up method for a computer system with Basic Input/Output System (BIOS), comprising:
enabling a cache memory after performing a Power On Self Test (POST) of the BIOS;
disabling the cache memory after initialing a system memory; and
initialing the cache memory.

7. The boot-up method of claim 6, wherein said cache memory can be selected as a level 1 cache memory, a level 2 cache memory, a level 3 cache memory, and a combination thereof.

8. The boot-up method of claim 6, wherein said system memory can be selected as a Static Random Access Memory (SRAM), Dynamic Random Access Memory (DRAM), a Synchronous Dynamic Random Access Memory (SDRAM), a Double Data Rate Random Access Memory (DDR), a Second Generation Double Data Rate Random Access Memory (DDR II), and one of other random access memories.

9. The boot-up method of claim 6, wherein the initial procedure for said system memory comprises the steps of:
detecting said system memory;
determining the relative parameters of said system memory; and
adjusting the Input/Output delay of the Bi-directional data strobe (DQS).
